(19) United States
(12) Patent Application Publication
(10) Pub. No.: US 2008/0284556 A1
(43) Pub. Date: Nov. 20, 2008

(54) Current breaker

(75) Inventor: Tsan-Chi Chen, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Sun-Lite Sockets Industry Inc., Taoyuan (TW)

(21) Appl. No.: 11/896,797

(22) Filed: Sep. 6, 2007

(30) Foreign Application Priority Data
May 18, 2007 (TW) 096208048

(51) Int. Cl. H01H 71/16; H01H 71/04

(52) U.S. Cl. 337/70; 337/79

(57) ABSTRACT

A current breaker includes a shell, a switching member, a movable conductor, a first conductive strip, a second conductive strip, a third conductive strip, a snap strip, a disengaging member and a locking member. In case of excessive current, the snap strip disfigures to move the disengaging member for releasing the locking member from the movable conductor, and then separates the movable conductor from the first conductive strip so as to cut off current. Moreover, even if the switching member should accidentally be compressed immovable in the ON condition, this current breaker still could work to cut off current automatically.

### BACKGROUND OF THE INVENTION

1. Field of the Invention

This invention relates to a current breaker, particularly to one provided with a snap strip in a shell, so when the current becomes excessive, with a switching member provided in the shell impossible to be swung to the OFF condition because of being accidentally compressed by something, the snap strip can still snap to cut off current.

2. Description of the Prior Art

Common electric switches generally function to turn on and off current to send electricity to electric appliances, and a safety switch is always used for cutting off power in case of excessive large current to protect electric appliances from burned or damaged. A safety switch, or a current breaker, automatically turns off power when an electric appliance is overloaded, so as to protect the electric appliances, thus it is very essential for a user whether the safety switch has high effectiveness or not.

A conventional current breaker shown in FIG. 1, includes a shell 10, a press key 11 pivotally installed on an upper surface of the shell 10, a first conductive strip 101, a second conductive strip 102 and a third conductive strip 103 all inserted in a bottom of the shell 10, a snap strip 12, and a push rod 13 in the shell 10.

The snap strip 12 has one end located on one end of the first conductive strip 101 in the shell 10, and the other end formed with a contact point 121 and a lead wire 122. The contact point 121 faces to the second conductive strip 102 and connected to a contact point 1104 of the second conductive strip 102. The lead wire 122 is connected to the third conductive strip 103. The push rod 13 has one end pivotally connected to one end of the bottom and the other end connected to the other end of the snap strip 12.

When the conventional current breaker is turned ON, the contact point 121 contacts with the contact point 104 to let current flow orderly through the first conductive strip 101, the snap strip 12 and the third conductive strip 103. Provided that the current suddenly rises up surpassing the safe value, the snap strip 12 is to be heated to disfigure instantly, forcing one end to bend towards the press key 11, with the contact point 121 of the snap strip 12 separated from the contact point 104 of the second conductive strip 102, automatically cutting off the power, with the press key 11 jumping back to the OFF position, protecting related electric appliances from damaged.

However, the conventional current breaker has a dangerous drawback that when the snap strip 12 has one end disfigured, the press key 11 is simultaneously to jump back to the OFF position. Should the press key 11 be disturbed by something, impossible to jump back from the ON position to the OFF position, the snap strip 12 might be have its one also impossible to disfigure, causing the contact point 121 kept contacting the contact point 104 of the second conductive strip 102. Thus, even the current becomes extremely excessive beyond the safe load, it is not cut off, potentially burning up related electric appliances and causing a fire if worse. Therefore, it is a pressing problem to upgrade safety of a conventional current breaker.

### SUMMARY OF THE INVENTION

This invention has been devised to offer a current breaker possible to automatically and surely cut off current in case of overloaded current.

### BRIEF DESCRIPTION OF DRAWINGS

This invention will be better understood by referring to the accompanying drawings, wherein:

FIG. 1 is a cross-sectional view of a conventional safety switch;

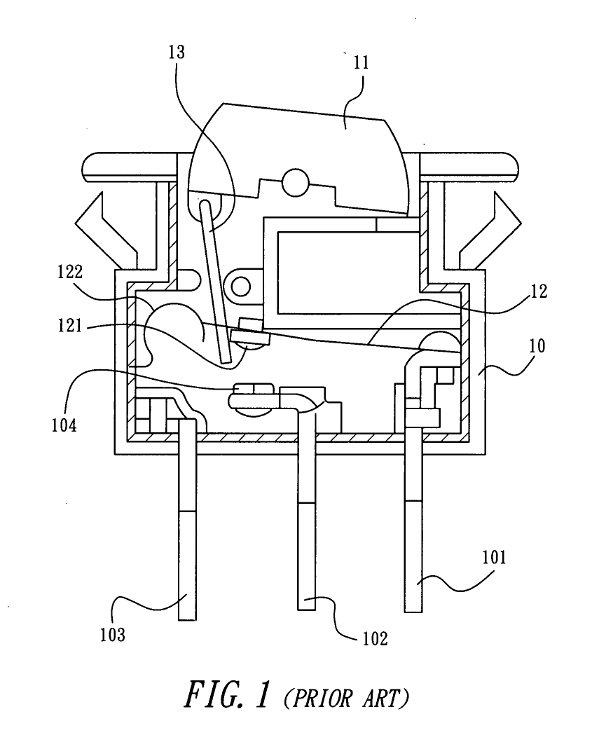

FIG. 2 is a cross-sectional view of a current breaker in the present invention, showing it in a first operation;

FIG. 3 is a cross-sectional view of the current breaker in the present invention, showing it in a second operation;

FIG. 4 is a cross-sectional view of the current breaker in the present invention, showing a press key compressed immovable by something;

FIG. 5 is a cross-sectional view of the current breaker in the present invention, showing it in a third operational condition;

FIG. 6 is an exploded perspective view of some components of the current breaker in the present invention;

FIG. 7 is a side view of the current breaker in the present invention;

### DETAILED DESCRIPTION OF THE PREFERRED EMBODIMENT

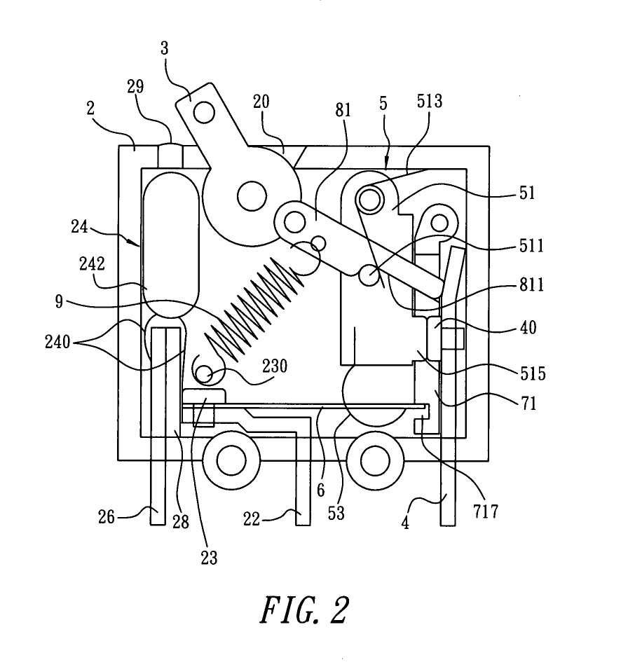

A current breaker in the present invention, as shown in FIG. 2, includes a shell 2, a switching member 3, a first conductive strip 4, a movable conductor 5, a snap strip 6, a disengaging member 71, and a locking member 81 as main components.

The shell 2 is provided with an opening 20 in an upper surface.

The switching member 3 has a first end pivotally connected in the shell 2, and a second end extending upward out of the opening 20 of the shell 2, handled to turn on and off power, as shown in FIG. 2. When the switching member 3 is pushed to a first side of the shell 2, the current beaker is ON. The first conductive strip 4 is made of copper, having a first end inserted downward through the bottom of the shell 2, and a second end extending in the interior of the shell 2. The movable conductor 5 is placed between the switching member 3 and the first conductive strip 4, having a first end pivotally connected near to the upper surface of the shell 2, and a second end contacting the first conductive strip 4. The snap strip 6 is made of a memory metal alloy, having a first end located in the shell 2 near its bottom, and a second end connected electrically to the movable conductor 5. The disengaging member 71 is placed between the movable conductor 5 and the first conductive strip 4, having a first end facing to the upper side of the shell 2, and a second end facing to the bottom of the shell 2 and also near a first end of the snap strip 6. The locking member 81 has a first end pivotally connected to the first end of the switching member 3, and a second end resting on a first end of the disengage member 71, with its intermediate lower surface resting on the movable conductor 5.

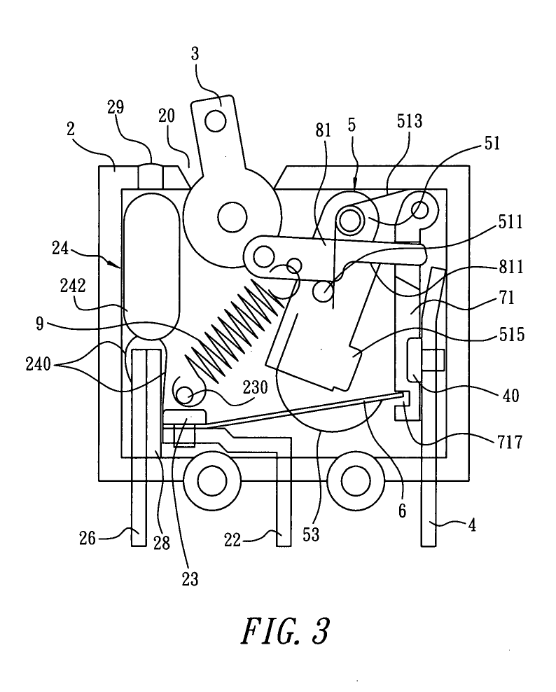

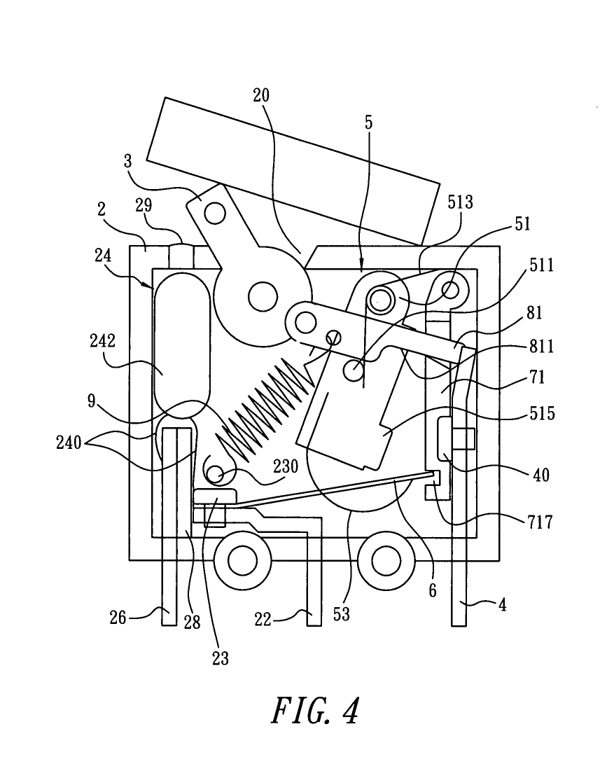

Next, as shown in FIG. 2, current flows orderly through the first conductive strip 4, the movable conductor 5, one soft wire 53 of the movable conductor 5, and the snap strip 6, when the current breaker is in the ON condition. If the current flowing through the current breaker suddenly rises excessively, letting the snap strip 6 disfigure owing to too high temperature, as shown in FIG. 3, the second end of the snap strip 6 may bend towards the upper side of the shell 2, pushing up the disengaging member 71, which then pushes upward the locking member 81 towards the upper side of the shell 2. Then the locking member 81 separates from the movable conductor 5, permitting the movable conductor 5 leave the first conductive strip 4, disrupting the current so that the relative circuit system connected to the current breaker may be prevented from burning up by excessive current. Moreover, as shown in FIG. 4, even if the switching member 3 in the ON condition should be compressed immovable by something and impossible to be pushed to turn off the current, the movable conductor 5 still can separate from the first conductive strip 4, cutting off the current, getting rid of the drawback of the conventional current breaker mentioned above.

Next, as shown in FIG. 2, a coil spring 9 is further installed in the shell 2, having a first end hooking a spring pin 230 fixed in the shell 2, and a second end hooking the locking member 81 near its first end, elastically pulling the first end of the locking member 81 towards the bottom of the shell 2 in case the current breaker is under ON condition. So the locking member 81 can have its lower side in contact with the movable conductor 5 to permit the current to flow through the first conductive strip 4, the movable conductive block 5, the soft wire 53 and the disengaging member 6.

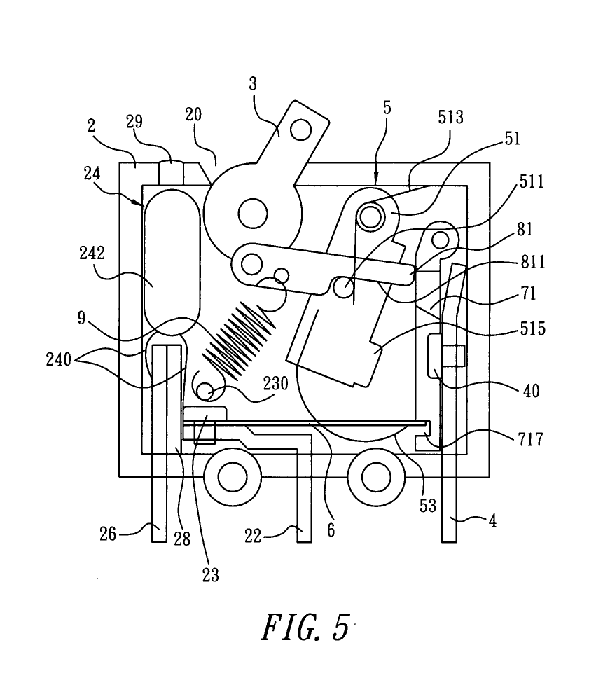

Moreover, referring to FIGS. 3 and 5, when the locking member 81 separates from the movable conductive block 5, the spring 9 can continue to pull the locking member 81 towards the switching member 3, and pushes continually the first end of the switching member 3 so that the switching member 3 may swing from a first end of the opening 20 to a second end thereof and cut off the current. Afterwards, if the snap strip 6 cools down owning to interruption of the current, the second end of the snap strip 6 bends down towards the bottom of the shell 2, permitting the locking member 81 also moves down towards the bottom of the shell 2, and contacts with the movable conductor 5, as shown in FIG. 2. Then the switching member 3 swings to the second end of the opening 20 of the shell 2, and simultaneously pushes the movable conductor 5 to contact with the first conductive strip 4 to turn on the current breaker again.

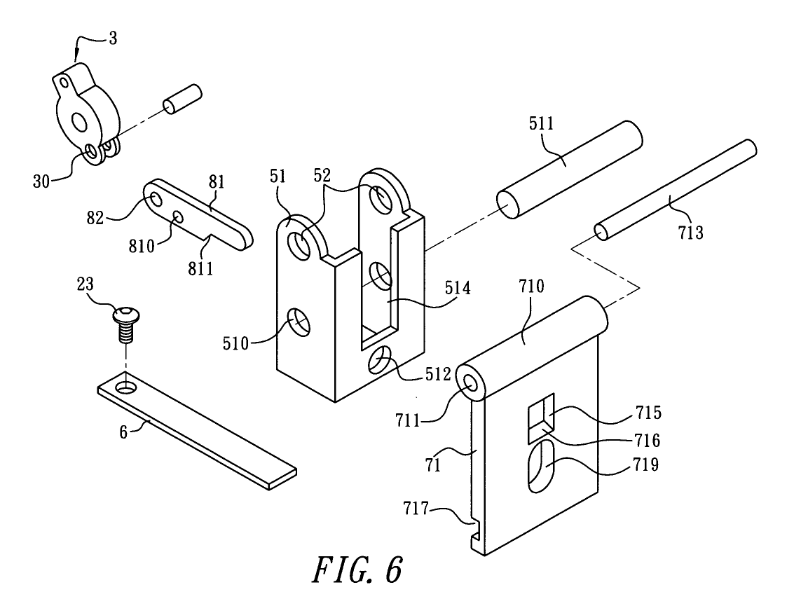

Next, referring to FIGS. 2 and 6, the movable conductor 5 is composed of a conductive block 51, a soft wire 53, a locking shaft 511 and a torsional spring 513. The conductive block 51 has two pivotal holes 52 at an upper end, and pivotally connected near to the upper side of the shell 2, and a lower end resting on the first conductive strip 4 so that the conductive block 51 may rotate in the shell 2 to move farther away from the first conductive strip 4. The soft wire 53 is a twisted copper wire, having a first end connected to the lower end of the conductive block 51 and a second end welded with the second end of the disengaging strip 6. Thus electrical connection between the conductive block 51 and the disengage strip 6 is never affected owing to the flexible property of the soft wire 53, no matter how the conductive block 51 may be moved, or how the disengaging strip 6 may disfigure. The current always flows through the soft wire 53 to the snap strip 6 as long as the lower end of the conductive block 51 rests on the first conductive strip 4.

The locking shaft 511 is deposited between a front wall and a rear walls in an intermediate portion of the conductive block 51, passing through two holes 510 in the front and the rear wall and contacting with a lower surface of the locking member 81. The torsional spring 513 and the upper end of the conductive block 51 are both pivotally connected near to the upper side of the shell 2, with the two ends of the torsional spring 513 respectively pressing on the upper side of the shell 2 and the locking shaft 511. Then the torsional spring 513 pushes the conductive block 51 farther from the first conductive strip 4, cutting off current, so no power can reach the related electrical system by means of the current breaker.

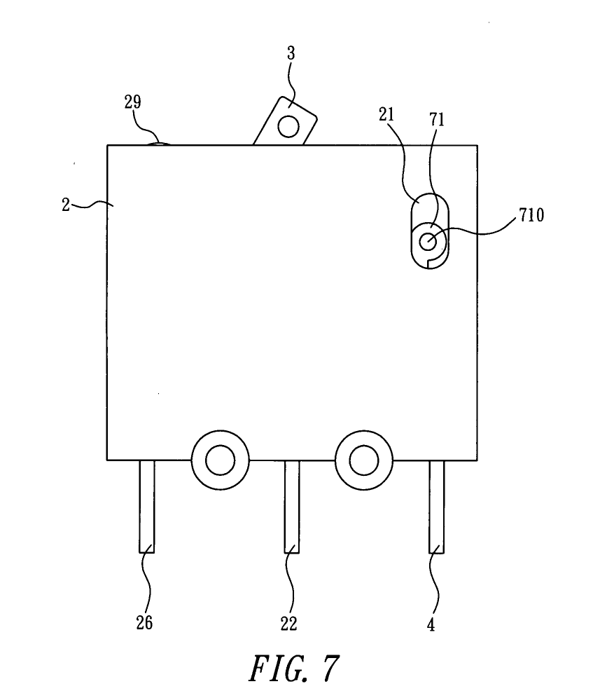

As shown in FIGS. 2, 6 and 7, the disengaging member 71 has a first end formed with a round elongate projection 710 at an upper end protruding out of two opposite sides and having two ends movably fitting in a limiting slot 21 bored in two sidewalls of the shell 2 so that the disengaging member is hung in the shell 2 by means of the round elongate projection 710, possible to move up and down in a limited distance. The round elongate projection 710 is provided with a center through hole 711 for a bar 713 to fit through, having an end facing to the bottom of the shell 2 and near the second end of the snap strip 6.

In addition, as shown in FIG. 2, 6 and 7, the locking member 81 has a pivotal hole 82 formed at a first end, and the switching member 3 has a pivotal hole 30 formed in a lower end, so the first end of the locking member 81 is pivotally connected to the pivotal hole 30 of the switching member 3 by means of a pivot. A second end of the locking member 81 passes through an avoiding opening 415 of the conductive block 51 and rests on the upper end of the disengaging member 71, with the underside resting on the locking shaft 511. Therefore, even if the switching member 3 is at the OFF position, current can still flow through the first conductive strip 4, the conductive block 5, the soft wire 53 and the snap strip 6. If the current suddenly becomes excessively high, forcing the snap strip 6 disfigure because of high temperature, the first end of the snap strip 6 curls up to push the disengaging member 71 upward to the upper side of the shell 2, separating the locking member 81 from the locking shaft 511, and subsequently forcing the conductive block 51 separate from the first conductive strip 4, cutting off the current flowing through the current breaker and subsequently the related electric appliances or system.

Next, as shown in FIGS. 2 and 6, the disengaging member 71 is provided with a large hole 715 in a center portion, and a recess 717 in an inner lower portion. The large hole 715 is provided with a push point 716 for the second end of the locking member 81 to rest thereon, so when the disengaging member 71 is pushed up, the locking member 81 is also lifted up together. The recess 717 is to receive the first end of the snap strip 6 to let the disengaging member 71 moved by the snap strip 6. The locking member 81 is provided with a spring hooking hole 810 in an intermediate portion for one end of the coil spring 9 to hook with, and a recess 811 formed in an underside of the first end portion to rest on the locking shaft 511. So when the disengaging member 71 moves the locking member 81 upward, the recess 811 separates from the locking shaft 511, permitting the conductive block 51 move off the first conductive strip 4, and at the same time the locking member 81 is pulled by the spring 9, moving the switching member to swing.

Referring to FIGS. 2 and 6, the conductive block 51 is provided with a first contact member 515 on a lower end facing the first conductive strip 4, and fixed in a rivet hole 512 of the conductive block 51 to contact a second contact member 40 formed on the first conductive strip 4 so that current can run through the first conductive strip 4 to the conductive block 51. The disengaging member 71 is further provided with a contact receiving hole 719 under the opening 715 for receiving the first contact member 515 and the second contact member 40 together therein, so the two contact members 515 and 40 may move a little therein for avoiding blocking the shifting of the disengaging member 71.

Besides, a second conductive strip 22 is fixed on the bottom of the shell 2, made of copper, having a first end inserted down through the bottom of the shell 2 and a second end extending parallel to the bottom of the shell 2, with a rivet 23 fixed on the second end for stabilizing the first end of the snap strip 6 and the second conductive strip 22 together in the shell 2. Then any electric system can be connected with the current breaker by means of the first and the second conductive strip 4 and 22 for preventing the electric system from damaged or burned.

Further, a light emitter 24 is installed in the shell 2, as shown in FIG. 2, for a user to check whether the current breaker is electrified or not. The light emitter 24 has two conductive feet 240 extending down to the bottom of the shell 2, and one of the two conductive feet 240 connected to the second conductive strip 22, and the other conductive foot 240 connected to a third conductive strip 26 extending down through the bottom of the shell 2 to expose out, in order to prevent the two conductive feet from contacting with each other. In addition, a separating strip 28 is added between the two conductive feet 240 on the bottom of the shell 2. The light emitter 24 has a lighting member 242 on its surface near the upper side of the shell 2, and the lighting member 242 is connected with the two conductive feet 240 to get power, and can be a light bulb. Further, a transparent window 29 is fitted in a side wall of the shell 2 to let the light of the lighting member 242 to shoot out of the shell 2 so that a use can know whether the current breaker is powered or not.

The current breaker in the invention has the following advantages.

1. When the current is overloaded, the snap strip 6 can snap to cut off the power, protecting electric appliances connected to the current breaker from damaged or burned.

2. No matter whether the switching member 3 is compressed immovable or not, the movable conductor 5 can separate from the first conductive strip 4, instantly cutting off the current, improving the flaw of the conventional current breaker, largely upgrading the safety of an electric circuit system using this current breaker.

3. A user can inspect whether the light emitter is lit up or not so as to decide the current breaker is powered or not.

While the preferred embodiment of the invention has been described above, it will be recognized and understood that various modifications may be made therein and the appended claims are intended to cover all such modifications that may fall within the spirit and scope of the invention.

What is claimed is:

1. A current breaker comprising:
A shell provided with an opening in an upper surface;
A switching member having a first end pivotally connected to an interior of said shell and a second end extending up through said opening out of said shell;
A first conductive strip having a first end inserting through a bottom of said shell to expose out of said shell and a second end extending up toward an upper side of said shell;
A movable conductor placed between said switching member and said first conductive strip, said movable conductor having a first end pivotally connected near said upper side of said shell and a second end resting on said first conductive strip;
A snap strip connected electrically to said movable conductor and having a first end fixed near a bottom of said shell and a second end that may curl up towards said upper side of said shell if said snap strip disfigures;
A disengaging member placed between said movable conductor and said first conductive strip and having a first end facing to said upper side of said shell and a second end facing to said bottom of said shell, said second end being near said second end of said snap strip, said disengaging member pushed towards said upper side of said shell when said second end of said snap strip curls up towards said upper side of said shell; and, A locking member having a first end pivotally connected to said first end of said switching member and a second end resting on said first end of said disengaging member, said locking member having its underside contact said movable conductor, said locking member moving towards said upper side of said shell and separating said underside of said locking member from said movable conductor when said disengaging member shifts towards said upper side of said shell, consequently said second end of said movable conductor moving away from said first conductive strip.

2. The current breaker as claimed in claim 1, wherein a coil spring is provided in said shell, having a first end fixedly hooked at a point in said shell and a second end connected to said first end of said locking member, by means of elasticity of said coil spring said first end of said locking member keeps on being pushed towards said switching member and said second end of said switching member moves from a first end of said opening of said shell to a second end of said opening under a condition that said movable conductor is separated from said first conductive strip.

3. The current breaker as claimed in claim 2, wherein said movable conductor comprises:
a conductive block having a first end pivotally connected near an upper side of said shell and a second end resting on said first conductive strip; and,
a soft wire having a first end connected to said second end of said conductive block and a second end connected to said first end of said snap strip.

4. The current breaker as claimed in claim 3, wherein said conductive block of said movable conductor further comprises:
a locking shaft placed through an intermediate portion of two sidewalls and contacting with an underside of said locking member;
a torsional spring pivotally connected to a point near said upper side of said shell together with said first end of said conductive block, said torsional spring having two ends pushing said upper side of said shell and said locking shaft respectively, by means of elasticity of said torsional spring said conductive block pushed to move towards said first conductive strip and said second end of said conductive block separating from said first conductive strip under a condition that said underside of said locking member is separated from said locking shaft.

5. The current breaker as claimed in claim 4, wherein said disengaging member comprises:
a round elongate projection formed at an upper end and having two ends protruding out of two sidewalls and movably fitting in two limit slots bored in two sidewalls of said shell;
an opening bored nearly at a center and near said second end of said disengaging member for receiving said second end of said locking member; and.
a recess formed in said second end of said disengaging member for receiving said second end of said snap strip.

6. The current breaker as claimed in claim 5, wherein said locking member is provided with a recess on an underside of said second end, said recess contacts with said locking shaft, and said locking member has its first end pushed said switching member to swing under a condition that said recess separates from said locking shaft by means of elasticity of said coil spring.

7. The current breaker as claimed in claim 6, wherein a second conductive strip is fixed to have a first end inserting through said bottom of said shell and a second end extending up in said shell, said second conductive strip has a second end fixed with a rivet, and said rivet fixes said second conducive strip and said first end of said disengaging member together with said shell.

8. The current breaker as claimed in claim 6, wherein a light emitter is installed in said shell, and said light emitter comprises:
a lighting member fixed near said upper side of said shell, said lighting member having an upper end facing to a transparent window fixed in said upper side of said shell; and,
two conducive feet having a first end connected to said lighting member, one of said two conductive feet connected to said second conductive strip, another of said two conductive feet connected to a third conductive strip provided on said bottom of said shell.

9. The current breaker as claimed in claim 6, wherein said conductive block has a first contact member on its second end, and said first contact member is connected to a second contact member fixed on said second end of said first conductive strip.

10. The current breaker as claimed in claim 6, wherein said disengaging member is provided with a contact hole between said opening and said recess, and said contact hole receives said first contact member and said second contact member together therein.

11. The current breaker as claimed in claim 6, wherein said shell further has a spring hooking pin for hooking an end of said coil spring.
